(19) United States
(12) Patent Application Publication
(10) Pub. No.: US 2003/0139149 A1
(43) Pub. Date: Jul. 24, 2003

(54) Joint apparatus for personal digital assistant (PDA) and multimedia module

(76) Inventors: Grace Kao, Taoyuan (TW); Jason Wang, Hsin-Chu (TW)

Correspondence Address: RABIN & BERDO, P.C., Suite 500, 1101 14th Street, N.W., Washington, DC, 20005, US

(21) Appl. No.: 10/052,627

(22) Filed: Jan. 23, 2002

(51) Int. Cl. H04B 1/38

(52) U.S. Cl. 455/90; 455/347

(57) ABSTRACT

The present invention provides a kind of joint apparatus for personal digital assistant (PDA) and multimedia module. As the PDA interface equipment combined with the joint apparatus, the multimedia module will affect on the PDA interface equipment immediately and further more storage the information from the multimedia module to the PDA interface equipment.

### BACKGROUND

1. Technical Field of the Invention

The present invention provides a kind of joint apparatus for personal digital assistant (PDA) and multimedia module, which comprises a boxed structure, an interface card component, a fixture assembly and an elastic assembly.

Since forcing the fixture assembly of joint apparatus outwardly and plugging the interface card of PDA interface equipment into the slot of PDA interface equipment. The elastic assembly will push the fixture assembly to connect with the joint apparatus to drive the bayonet lock and to interlock the PDA interface equipment, thus the function of multimedia module is able to affect on and install in PDA interface equipment obviously.

2. Description of the Prior Art

In utilizing of conventional interface card, since an interface card plugged into the slot of PDA interface equipment, as unlocking an interface card which would be pressed downwardly to make a release between the interface card and the slot, consequently the interface card is able to removed out. Contrarily, an outwardly compelling force to draw the interface card from the slot which will cause to the damage of the interface card or the impairment of the inner portion of the slot of PDA interface equipment.

### SUMMARY OF THE INVENTION

The present invention relates to an inner structure technique for the joint apparatus for personal digital assistant (PDA) and multimedia module in an assembling matter. The effect of multimedia module been will display on the PDA interface equipment immediately as well as the technique of the storage will be stored in the PDA.

The further object of the present invention is a connection of the multimedia module and the PDA interface equipment to prevent this connection from falling apart.

The foregoing object of said invention is to avoid forgetting to release the Inlay State into freedom and compelling from taking out the interface card. Such behavior will damage the interface card by the compelling force.

### BRIEF DESCRIPTION OF THE DRAWING

For a better understanding of the present invention as well as other objects and features herein disclosed, reference is made to following detailed disclosed of this invention taken in conjunction with drawings herein:

FIG. 1 is a schematic diagram of a joint apparatus for personal digital assistant (PDA) and multimedia module

FIG. 2 is a bottom view of the board fence according to present invention.

FIG. 3 is an exploded diagram of an upper lid, a set of PCB components assembly, and a bottom lid.

FIG. 4 is an exploded diagram of the elastic assembly and bottom lid.

FIG. 5 is an exploded diagram of the fixture assembly and bottom lid.

FIG. 6 is an assemble demonstration of the board fence.

FIG. 7 is a demonstration of the fixture assembly pressing onto the elastic assembly.

FIG. 8 is the direction vector of assembled of the interface equipment and present invention.

FIG. 9 is a complete practice diagram of the interface equipment and present invention.

### TERMS OF ITEMS

| | | | |
|---|---|---|---|
| (10) | boxed structure | | |
| (11) | upper lid | (12) | bottom lid |
| (121) | bracer | (122) | positioned pillar |
| (123) | elastic positioned slot | (124) | interlock |
| (13) | board fence | (131) | stopper |
| (132) | plugging hole | (133) | positioned slot |
| (134) | rib | | |
| (20) | PCB components assembly | | |
| (21) | PCB | (211) | pin socket |
| (22) | interface card | (221) | pins |
| (30) | elastic assembly | | |
| (31) | elastic extending portion | (32) | elastic extending portion |
| (33) | flat portion | | |
| (40) | fixture assembly | | |
| (41) | extending portion | (411) | chamfered portion |
| (42) | pin hole | (43) | bayonet lock |
| (44) | positioned block | | |
| (50) | PDA interface equipment | (51) | plug-in hole |

### DESCRIPTION OF THE PREFERRED EMBODIMENTS

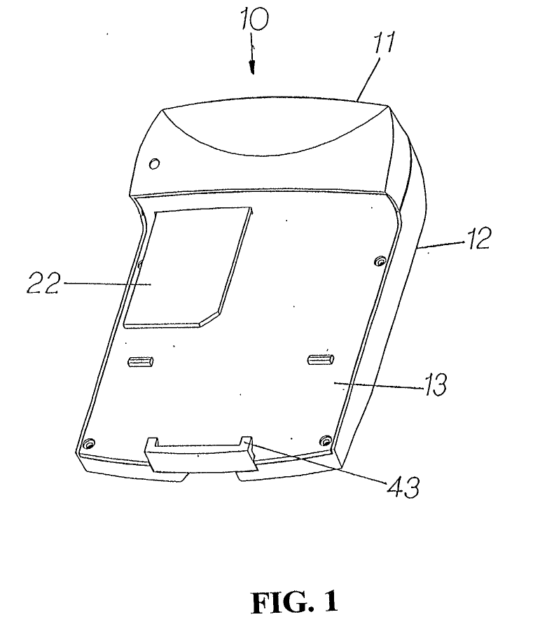

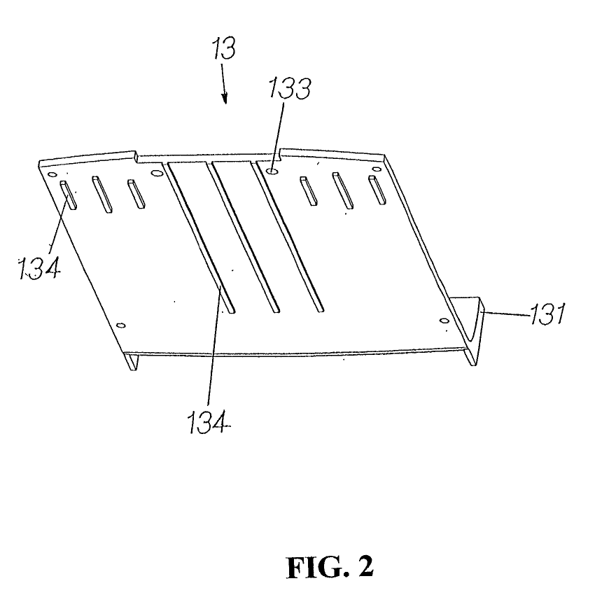

Please refer to follow as FIGS. 1 to 6 shown as the present invention comprises a boxed structure (10), a PCB components assembly (20), an elastic assembly (30) and a fixture assembly (40).

Please refer to FIGS. 1, 2 and 3 shown as the present invention, herein the boxed structure (10) comprises an upper lid (11), a bottom lid (12), and a board fence. The upper lid (11) is assembled onto the forward portion of the bottom lid (12) to protect the components that are mounted in its forward portion. The bottom lid (12) is main structure of the present invention, which can be assembled lots of components and structures. The bottom lid (12) includes several ribs (121) mounted on the rear portion, herein the positioned pillar (122) and elastic positioned slot (123) are mounted on both two lateral sides of the rear portion of the bottom lid (12). Additionally, an interlock (124) is opened at the rear end of the bottom lid (12). The board fence (13) is a flat board having an L-type-like stopper (131) at its one end, herein a plugging hole (132) is opened at the stopper (131), and the back side of board fence (13) with a positioned slot (133) and several ribs (134) mounted on.

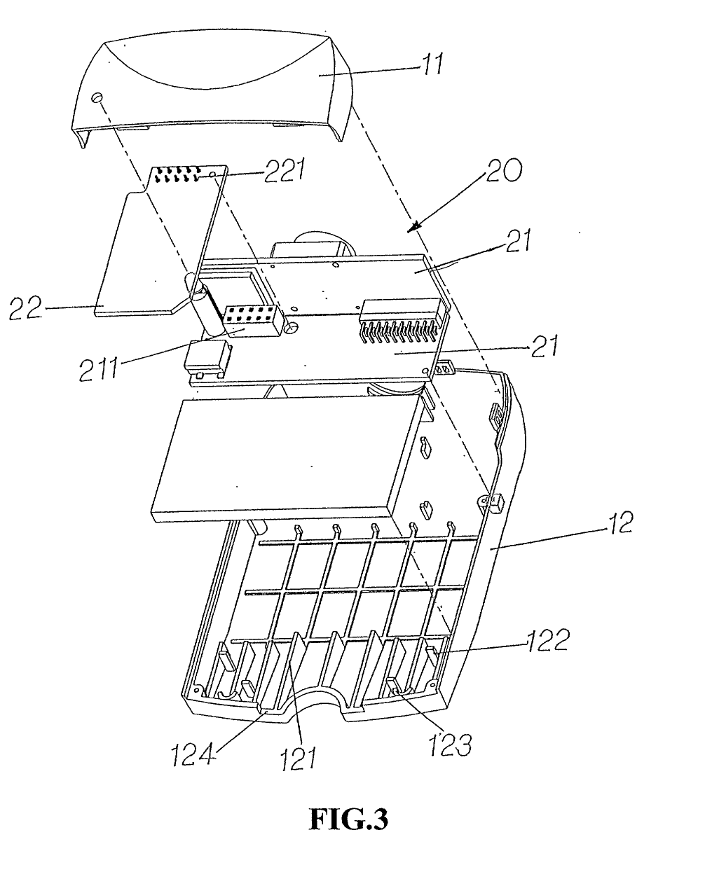

Please refer to FIG. 3 shown of present invention. The PCB components assembly (20), which comprises a PCB (21) and an interface card (22), primarily function as delivery information.

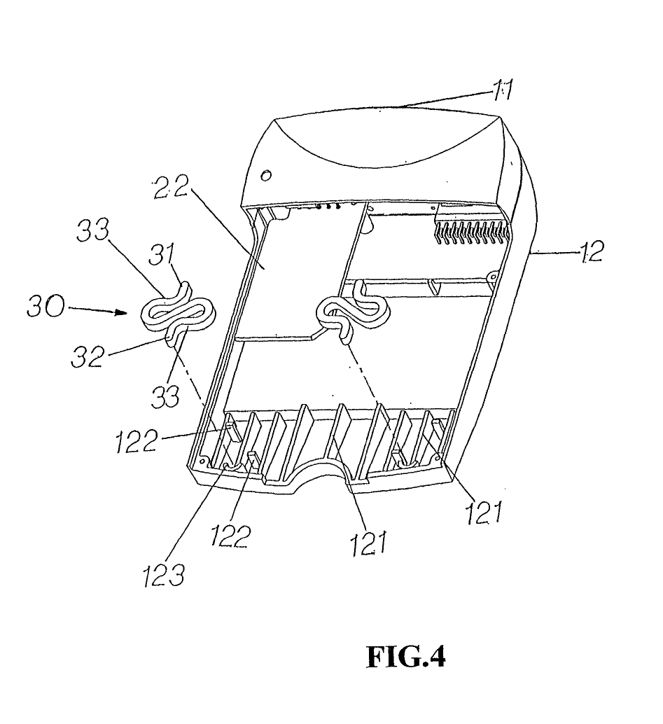

Please refer to FIG. 4 shown of present invention, wherein the elastic assembly (30) is an S-type-like and flexible object, which the elastic extending portions (31) (32) stretching outwardly both former and rear ends.

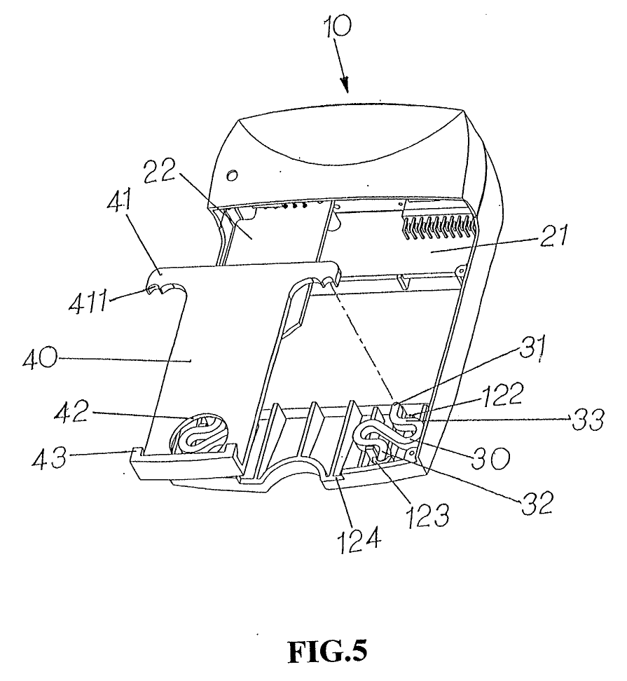

Please refer to FIG. 5 shown of present invention, wherein the fixture assembly (40) is a long board object, which the elastic extending portions (41) are stretched outwardly on both lateral sides of one end. Herein two chamfered portions (411) are opened towards the fixture assembly (40) on each extending portion (41). There are a pin hole (42), a bayonet lock (43), and a positioned block (44) on the other side of the fixture assembly (40).

Please refer to FIG. 3 shown of present invention, the pins (221) of interface card (22) plugs into the pin socket (211) of PCB (21) to form a PCB components assembly (20), which will be assembled to the former portion of the bottom lid (12). Afterwards, the upper lid (11) shall face the former portion of bottom lid (12) and install on it.

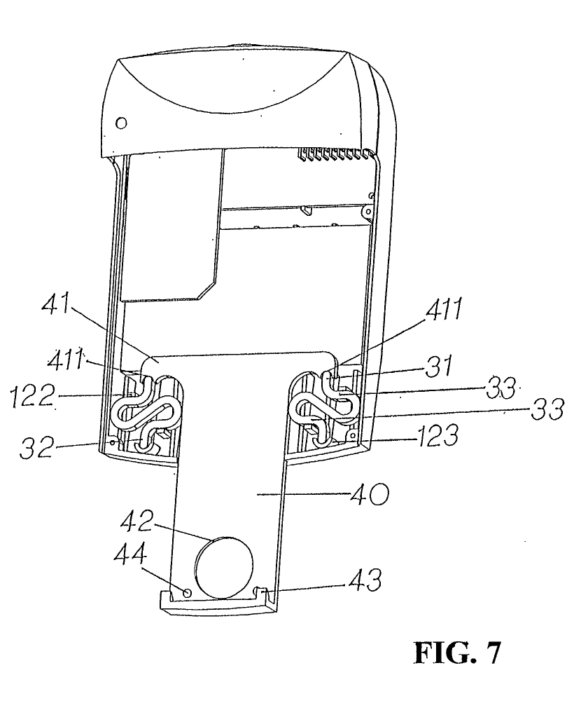

Please refer to FIGS. 4 and 7 shown of present invention, the elastic assembly (30) shall be assembled on top of the ribs (121) of the bottom lid (12). One flat portion (33) of the elastic assembly (30) leans against the positioned pillar (122). In the meanwhile, the other flat portion (33) is supported by the positioned pillar (122). One of the elastic extending portion (31) stays upturned, and the other elastic extending portion (32) inlayed the elastic positioned slot (123).

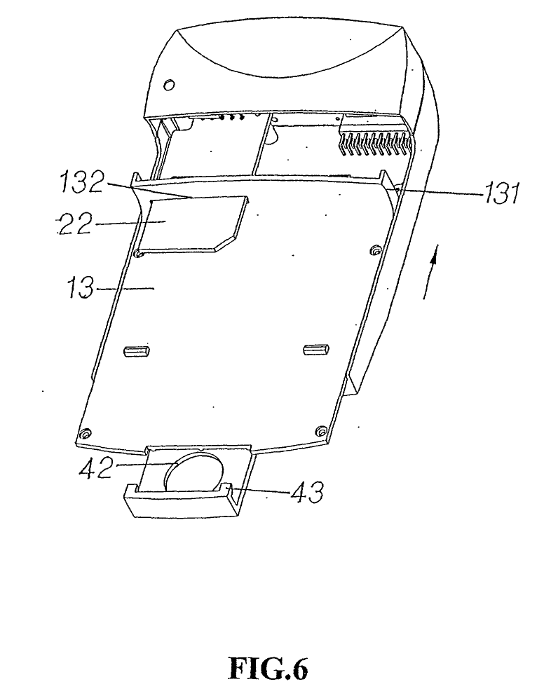

Please refer to FIGS. 5 and 6 shown of present invention, the fixture assembly (40) shall be assembled above the interlock (124) of the bottom lid (12), herein the end with bayonet lock (43) shall face outwardly. Thus the board fence (13) shall face the interface card (132) through the plugging hole (132) and make the interface card (22) inserts to the plugging hole (132) of the board fence (13). Thus the board fence (13) will assemble on the bottom lid (12).

Please refer to FIGS. 1, 2 and 7 shown of present invention, as the fixture assembly (40) is inside the boxed structure (10), the positioned block (44) of fixture assembly (40) will tightly wedge to the positioned slot (133) of board fence (13) to fix the fixture assembly (40) for avoiding its loose

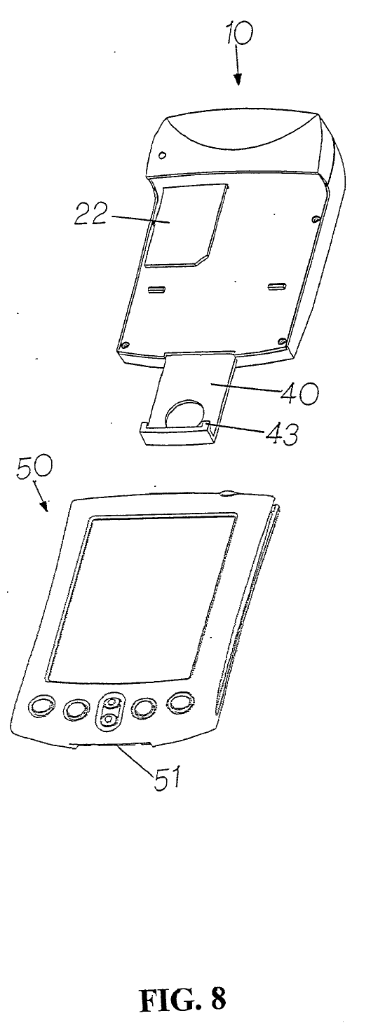

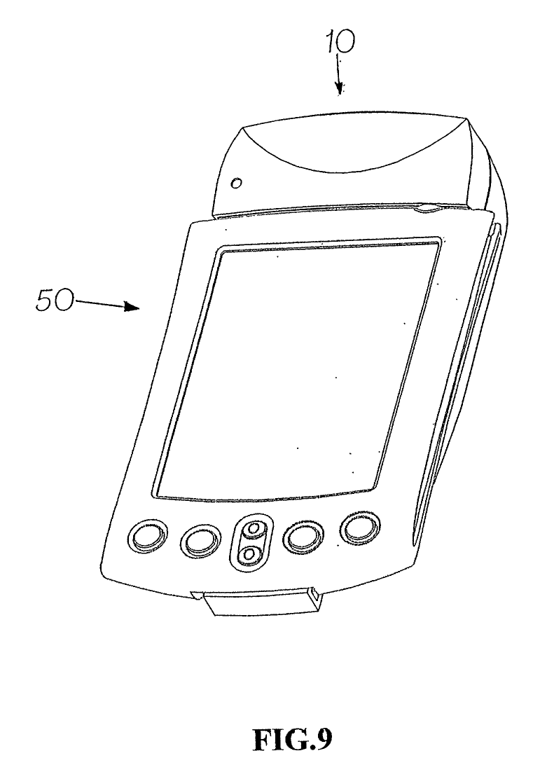

Please refer to FIGS. 7, 8 and 9 shown of present invention, as forcing the pin hole (42) of the fixture assembly (40) pulled outwardly from the boxed structure (10). Then the chamfered portion (411) on the extending portion (41) will contact the elastic extending portion (31) of elastic assembly (30). Thus, the extending portion (41) will press on the elastic assembly (30). In the meanwhile, the slot (not shown on the drawings) of PDA interface equipment (50) faces the interface card (22) of the boxed structure (10) in order to plug the interface card (22) into the slot (not shown on the drawings) of the PDA interface equipment (50). This connection makes interface card (22) keep the Inlay State in the slot (not shown on the drawings). Then, the PDA interface equipment (50) and the boxed structure (10) shall be press to each other in order to release the interface card (22) from the Inlay State. After stopping the pressing force, there will be a counteraction force from the elastic assembly (30) pushing on the fixture assembly (40). The elastic assembly (30) will drive its bayonet lock (43) to inlay the plug-in hole (51) of the PDA interface equipment (50). Thus, the PDA interface equipment (50) and the boxed structure (10) will be a connecting combination that uneasily falling off. On the contrary, in order to release the connecting combination of the PDA interface equipment (50) and the boxed structure (10), the bayonet lock (43), which wedged in the plug-in hole, shall be released. Moreover, the bayonet lock (43) shall be directly drawn out from the boxed structure (10). Similarly, the interface card (22) is removed from the PDA interface equipment (50).

While this invention has been described in conjunction with particular embodiments, it is evident that alternatives, modifications and variations will now be apparent to those skilled in the art. Accordingly, the present invention is intended to embrace all such alternatives, modifications and variations and fall within the spirit and scope of the appended claims.

What is claimed is:

1. A joint apparatus for personal digital assistant (PDA) and multimedia module essentially comprising of:
a boxed structure comprising of an upper lid, a bottom lid and a board fence,
a set of PCB components assembly combining by a PCB and an interface card which are deposited at said bottom lid for delivering information,
a fixture assembly arranged at said bottom lid, herein the upper portion of said fixture assembly been compressed by said board fence for fixing the PDA interface equipment, and
an elastic assembly inlayed said bottom lid adjacently,
whereby composition of aforesaid components, as inserting the interface card of said boxed structure into the slot of PDA interface equipment, herein said interface card will place in the slot of said PDA interface equipment, whereby forcing outwardly said fixture component, the bayonet lock will lock said PDA interface equipment, said boxed structure and said PDA interface equipment will be contacted for releasing said interface card to fix said PDA interface equipment on said boxed structure, herein a released locked stage in interface card which only removing said bayonet lock of PDA interface equipment to draw the PDA interface equipment off, thus, no more releasing said interface card;

2. According to claim 1 of said joint apparatus for personal digital assistant (PDA) and multimedia module, wherein said fixture assembly is T-type like, one end of said fixture assembly with a bayonet lock, a pin hole and a positioned block, and the other end with two outward-sides which respective extend an extending portion, herein every said extending portion opened a chamfered portion;

3. According to claim 1 of said joint apparatus for personal digital assistant and multimedia module, wherein said fixture assembly curves as S-type like, herein both of the forward portion and rear portion of said fixture assembly are stretching outwardly as an elastic extending portion;

4. According to claim 1 of said joint apparatus for personal digital assistant and multimedia module, wherein as said fixture assembly being arranged into said boxed structure, herein the positioned block of said fixture assembly will interlock with said positioned slot of said board fence for conveniently fabricating and positioning said fixture assembly to be fabricated;

5. According to claim 1 of said joint apparatus for personal digital assistant and multimedia module, wherein as forcing and pulling outwardly onto said fixture assembly, said chamfered portion of said assembly will contact said elastic extending portion of said elastic assembly, thus said elastic structure been compressed, a counteraction force will come to said elastic structure to pull said fixture assembly as well as drive said bayonet lock of said fixture assembly inlayed said PDA interface equipment for secure combining said boxed structure in case of falling off;

6. According to claim 1 of joint apparatus for personal digital assistant and multimedia module, wherein said fixture assembly and said elastic assembly will reduce friction because of rib, thus said elastic assembly will work efficiently onto said fixture assembly.
